(19) United States
(12) Patent Application Publication
(10) Pub. No.: US 2009/0213717 A1
(43) Pub. Date: Aug. 27, 2009

(54) METHOD OF ADJUSTING INCLINATION OF OBJECTIVE LENSES, METHOD OF PRODUCING OPTICAL PICKUP, DEVICE FOR ADJUSTING INCLINATION OF OBJECTIVE LENSES, OPTICAL PICKUP COMPONENT, OPTICAL PICKUP, AND OPTICAL INFORMATION RECORDING AND REPRODUCING DEVICE

(75) Inventors: Keiichi Matsuzaki, Osaka (JP); Hideki Hayashi, Nara (JP); Hidenori Wada, Kyoto (JP); Kanji Wakabayashi, Kyoto (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 11/571,327

(22) PCT Filed: Apr. 27, 2006
(86) PCT No.: PCT/JP2006/308907

§ 371 Date: Dec. 27, 2006

(30) Foreign Application Priority Data
Apr. 28, 2005 (JP) 2005-131956

(51) Int. Cl. G11B 7/135

(52) U.S. Cl. 369/112.23; G9B/7.112

(57) ABSTRACT

A method of adjusting the tilt of objective lenses in an optical pickup having a plurality of light sources, an optical pickup component with a plurality of objective lenses which converge light from the plurality of light sources on an optical information recording medium and a movable part which holds the plurality of objective lenses, an actuator which drives the movable part of the optical pickup component, and a base on which the actuator is arranged and an optical system which introduces light emitted from the plurality of light sources to the plurality of objective lenses is constituted, which are capable of producing an optical pickup with a plurality of objective lenses while tilt is being simply adjusted, the method includes:

a first tilt adjustment step of adjusting the tilt of the plurality of objective lenses with respect to the optical information recording medium with the optical pickup component temporarily arranged at a predetermined position on the base; and

a tilt detecting step of detecting the tilt of the plurality of objective lenses after the first tilt adjustment step has been completed.

### CROSS-REFERENCE TO RELATED APPLICATIONS

This application is a U.S. national phase application of PCT International Patent Application No. PCT/JP2006/308907 filed Apr. 27, 2006, claiming the benefit of priority of Japanese Patent Application No. 2005-131956 filed Apr. 28, 2005, all of which are incorporated by reference herein in their entirety.

### TECHNICAL FIELD

The present invention relates to a method of adjusting the tilt of an objective lens, a method of manufacturing an optical pickup, a device for adjusting the tilt of an objective lens, optical pickup component, optical pickup and optical information recording and reproducing device.

### BACKGROUND ART

In an optical pickup assembling process, it is required to adjust the tilt of an actuator for driving an objective lens to align the object lens with an optical information recording medium. For a conventional method of adjusting the tilt of an actuator, a method has been used in which a microscope, camera and monitor are used and a cover glass equal in thickness to an optical information recording medium is placed in parallel with a reference plane instead of the optical information recording medium to observe the spot of an objective lens formed on the cover glass by magnifying it with the microscope, on the basis of which the tilt of the actuator is adjusted (refer to, for example, Japanese Patent Laid-Open No. 6-36321).

FIG. 7 shows one example of the principal components of a device for performing a conventional method of adjusting an optical head. In the same figure, reference numeral 101 denotes a housing for an optical pickup, 102 a deflection prism, 103 an actuator, 104 a screw, 105 an objective lens, 106 a cover glass, 107 a microscope, 108 a camera, 109 a camera controller, 110 a monitor display and 111 a laser beam.

As shown in FIG. 7, the housing 101 for the optical pickup is provided with the deflection prism 102. The actuator 103 is situated over the housing 101 and provided with a movable part 103a inside which the objective lens 105 is fixed, a housing part 103b for housing the movable part 103a and a wire 103c for elastically holding the movable part 103a and housing part 103b. The movable part 103a contains a coil (not shown). The housing part 103b is provided with a magnet. Electromagnetic force generated by the coil by energizing the wire 103c serving also as wiring to the coil moves the movable part 103a toward a tracking and a focusing direction in the housing part 103b. Incidentally, when voltage is not applied across the coil, the movable part 103a is held by elastic force of the wire 103c and the actuator is adjusted in this state.

The actuator 103 is fixed to the housing 101 with the screw 104. Loosing or tightening the screw 104 can adjust the tilt of the actuator 103. The cover glass 106 equal in thickness to the protective layer of an optical information recording medium is disposed over the actuator 103 in parallel with the housing 101 of the optical pickup.

Hitherto, the tilt of the actuator has been adjusted in the following procedures. First, a laser beam 111 is incident on the deflection prism 102 to observe a spot formed on the cover glass 106 by the objective lens 105 through the microscope 107. The spot image received by the camera 108 connected to the microscope 107 is displayed on the monitor display 110 via the camera controller 109.

Secondly, an operator adjusts the tilt of the actuator 103 while monitoring the indication of the spot so that a primary first sidelobe becomes symmetrical. The tilt of the actuator 103 is adjusted through the above procedures.

The adjustment is performed to improve the shape of the spot by adjusting the tilt of the objective lens 105 built into the actuator 103 with respect to the optical information recording medium.

In an optical pickup having a plurality of light sources and a plurality of objective lens corresponding thereto to cope with writing into and reading from the optical information recording medium in plural formats such as CD/DVD and Blu-ray Disc, however, the tilt of respective objective lenses arranged on a movable part having a lens holder requires to be adjusted. This is because the adjustment of the tilt of the whole actuator 103 described above equally changes the tilt of the plural objective lenses.

If two objective lenses are provided in the movable part 103a, the tilt of each objective lens is adjusted inside the actuator 103. At this point, the following problem arises.

For example, a method is conceivable in which a first objective lens is fixed into the movable part 103a, a second objective lens is arranged so that it can be freely adjusted toward the direction of tilt inside the movable part, the tilt of the first objective lens is adjusted by adjusting the tilt of the movable part 103a itself and the tilt of the second objective lens is adjusted by an adjusting mechanism connected to a jig externally holding the second objective lens.

However, since the movable part is fixed to the housing part 103b with the wire 103c, the movement of only the movable part 103a at the time of adjusting the tilt of the first objective lens burdens the wire 103c to a load such as bending, torsion and others, which may break down the wire 103c.

On the other hand, if the first objective lens is arranged so that it can be freely adjusted inside the movable part 103a, the movable part 103a requires to be held by another way by means of jig. Even if the movable part is held with the jig, the wire 103c is directly or indirectly subjected to a load, which may cause a breakdown.

The present invention has been made to solve such problems and has its purpose to provide a method of adjusting the tilt of an objective lens, a method of manufacturing an optical pickup, a device for adjusting the tilt of an objective lens, optical pickup components, optical pickup and optical information recording and reproducing device, which are capable of producing an optical pickup with a plurality of objective lenses while tilt is being simply adjusted.

### DISCLOSURE OF THE INVENTION

The 1st aspect of the present invention is a method of adjusting the tilt of an object lens in an optical pickup having a plurality of light sources, an optical pickup component with a plurality of objective lenses which converge light from the plurality of light sources on an optical information recording medium and a movable body which holds the plurality of objective lenses, an actuator which drives the movable body of the optical pickup component, and a base on which the actuator is arranged and an optical system which introduces light emitted from the plurality of light sources to the plurality of objective lenses is constituted, the method comprising:

a first tilt adjustment step of adjusting the tilt of the plurality of objective lenses with respect to the optical information recording medium with the optical pickup component temporarily arranged at a predetermined position on the base; and

a tilt detection step of detecting the tilt of the plurality of objective lenses after the first tilt adjustment step has been completed.

The 2nd aspect of the present invention is the method of adjusting the tilt of the objective lens according to the 1st aspect of the present invention, wherein

at least one of the plurality of objective lenses of the optical pickup component is fixed to the movable body in advance,

the remainder of the plurality of objective lenses are held inside the movable body in such a manner that tilt thereof is adjustable with respect to the optical information recording medium,

the first tilt adjustment step for the objective lens fixed to the movable body is performed by moving the movable body, and the step for the remainder of the objective lenses is performed by directly moving the lenses, and

the method further comprises

a step of completing the optical pickup component by fixing the remainder of the objective lenses to the movable body after the first adjustment step has been completed.

The 3rd aspect of the present invention is the method of adjusting the tilt of the objective lens according to the 1st aspect of the present invention, wherein at least any one of the movable body and the plurality of objective lenses has a reflecting part which reflects light, and

the tilt detection step uses irradiation light for measuring tilt with respect to the reflecting part.

The 4th aspect of the present invention is the method of adjusting the tilt of the objective lens according to the 3rd aspect of the present invention, wherein the reflecting part is a reflecting mirror provided on the movable body.

The 5th aspect of the present invention is the method of adjusting the tilt of the objective lens according to the 3rd aspect of the present invention, wherein the reflecting part is provided on at least any one of the plurality of objective lenses and has a flat part formed at the edge part of a surface where light from the light source is incoming or at the edge part of a surface where light from the light source is outgoing, in the objective lens.

The 6th aspect of the present invention is the method of adjusting the tilt of the objective lens according to the 5th aspect of the present invention, wherein the flat part is formed around the periphery of the incoming or the outgoing surface and is an annular area having a predetermined width “w” (where, w≧0.1 mm).

The 7th aspect of the present invention is the method of adjusting the tilt of the objective lens according to the 5th aspect of the present invention, wherein the reflecting part has a flat part also on the side where the reflecting part does not have the flat part on the incoming or the outgoing surface, and one of the flat parts is a mirror plane reflecting light and the other of the flat parts is a rough surface diffusing light.

The 8th aspect of the present invention is the method of adjusting the tilt of the objective lens according to the 7th aspect of the present invention, wherein the flat part on the incoming surface is the rough surface.

The 9th aspect of the present invention is the method of adjusting the tilt of the objective lens according to the 1st aspect of the present invention, wherein the plurality of objective lenses are two objective lenses; the first and the second one.

The 10th aspect of the present invention is the method of adjusting the tilt of the objective lens according to the 1st aspect of the present invention, further comprising a recording step of recording information on the tilt of the objective lenses detected by the tilt detection step.

The 11th aspect of the present invention is the method of adjusting the tilt of the objective lens according to the 10th aspect of the present invention, wherein the recording step is such that the information on tilt is recorded in at least any one of the base, the optical pickup component and the actuator.

The 12th aspect of the present invention is the method of adjusting the tilt of the objective lens according to the 10th aspect of the present invention, wherein the recording step is performed in such a manner that the information on tilt is recorded by barcode information.

The 13th aspect of the present invention is the method of adjusting the tilt of the objective lens according to the 10th aspect of the present invention, wherein the recording step is performed in such a manner that the information on tilt is recorded in an integrated circuit provided on the base.

The 14th aspect of the present invention is the method of adjusting the tilt of the objective lens according to the 1st aspect of the present invention, wherein the tilt detection step is performed using an automatic collimator.

The 15th aspect of the present invention is the method of adjusting the tilt of the objective lens according to the 1st aspect of the present invention, wherein the first tilt adjustment step is performed in such a manner that outgoing light spots converged by the plurality of objective lenses become symmetrical with respect to the optical axis of light from the light source and are minimized.

The 16th aspect of the present invention is the method of adjusting the tilt of the objective lens according to the 1st aspect of the present invention, wherein the first tilt adjustment step is performed in such a manner that the coma aberration of light outgoing from the first and the second objective lenses is minimized.

The 17th aspect of the present invention is a method of manufacturing an optical pickup having a plurality of light sources, an optical pickup component with a plurality of objective lenses which converge light from the plurality of light sources on an optical information recording medium and a movable body which holds the plurality of objective lenses, an actuator which drives the movable body of the optical pickup component, and a base on which the actuator is arranged and an optical system which introduces light emitted from the plurality of light sources to the plurality of objective lenses is constituted, the method comprising:

a combining step of integrally combining the optical pickup component with the actuator; and

a fixing step of fixing the optical pickup component combined with the actuator to the base; wherein

the fixing step has a second tilt adjustment step of adjusting the tilt of the actuator combined with the optical pickup component so that the tilt of the plurality of objective lenses obtained at the tilt detection step in the method of adjusting the tilt of the objective lenses according to claim 1 is reproduced.

The 18th aspect of the present invention is the method of manufacturing the optical pickup according to the 17th aspect of the present invention, wherein the combining step is such that the optical pickup component is connected to the actuator with a wire for driving the optical pickup component.

The 19th aspect of the present invention is the method of manufacturing the optical pickup according to the 18th aspect of the present invention, wherein the wire is connected to the pickup component at least prior to the start of the combining step.

The 20th aspect of the present invention is a device for adjusting the tilt of an objective lens in an optical pickup having a plurality of light sources, an optical pickup component with a plurality of objective lenses which converge light from the plurality of light sources on an optical information recording medium and a movable body which holds the plurality of objective lenses, an actuator which drives the movable body of the optical pickup component, and a base on which the actuator is arranged and an optical system which introduces light emitted from the plurality of light sources to the plurality of objective lenses is constituted, the device comprising:

a first tilt adjusting part which adjusts the tilt of the plurality of objective lenses with respect to the optical information recording medium with the optical pickup component temporarily arranged at a predetermined position on the base; and

a tilt detecting part which detects the tilt of the plurality of objective lenses after the first step has been completed.

The 21st aspect of the present invention is the device for adjusting the tilt of an objective lens according to the 20th aspect of the present invention, further comprising a recording part which records information on the tilt of the objective lens detected by the first tilt adjusting part.

The 22nd aspect of the present invention is the device for adjusting the tilt of an objective lens according to the 21st aspect of the present invention, wherein the recording part records the information on the tilt of the objective lens in at least any one of the base, the optical pickup component and the actuator.

The 23rd aspect of the present invention is the device for adjusting the tilt of an objective lens according to the 22nd aspect of the present invention, wherein the recording part records the information on the tilt by barcode information.

The 24th aspect of the present invention is the device for adjusting the tilt of an objective lens according to the 22nd aspect of the present invention, wherein the recording part records the information on the tilt in an integrated circuit provided in the base.

The 25th aspect of the present invention is the device for adjusting the tilt of an objective lens according to the 20th aspect of the present invention, wherein the first tilt adjusting part has an automatic collimator.

The 26th aspect of the present invention is an optical pickup component comprising:

a plurality of objective lenses which converge light from a plurality of light sources on an optical information recording medium; and

a movable body which holds the plurality of objective lenses; wherein

at least any one of the movable body and the plurality of objective lenses has a reflecting part which reflects light.

The 27th aspect of the present invention is the optical pickup component according to the 26th aspect of the present invention, wherein the reflecting part is a reflecting mirror provided on the movable body.

The 28th aspect of the present invention is the optical pickup component according to the 26th aspect of the present invention, wherein the reflecting part is provided on at least any one of the plurality of objective lenses and has a flat part formed at the edge part of a surface where light from the light source is incoming or at the edge part of a surface where light from the light source is outgoing.

The 29th aspect of the present invention is the optical pickup component according to the 28th aspect of the present invention, wherein the flat part is formed around the periphery of the incoming or the outgoing surface and is an annular area having a predetermined width “w” (where, w≧0.1 mm).

The 30th aspect of the present invention is the optical pickup component according to the 28th aspect of the present invention, wherein the reflecting part has a flat part also on the side where the reflecting part does not have the flat part on the incoming or the outgoing surface, and

one of the flat parts is a mirror plane reflecting light and the other of the flat parts is a rough surface diffusing light.

The 31st aspect of the present invention is the optical pickup component according to the 28th aspect of the present invention, wherein the flat part on the incoming surface is the rough surface.

The 32nd aspect of the present invention is the optical pickup component according to the 26th aspect of the present invention, wherein the plurality of objective lenses are two objective lenses; the first and the second one.

The 33rd aspect of the present invention is an optical pickup comprising:

a plurality of light sources;

the optical pickup component according to claim 26;

an actuator which drives the movable body of the optical pickup component; and

a base on which the actuator is arranged and an optical system which introduces light emitted from the plurality of light sources to the plurality of objective lenses is constituted.

The 34th aspect of the present invention is the optical pickup according to the 33rd aspect of the present invention, wherein one light from the plurality of light sources converged by any of the plurality of objective lenses on the optical information recording medium is 380 nm to 420 nm in wavelength, and the other light from the plurality of the light sources converged by any of the other of the plurality of objective lenses on the optical information recording medium is 600 nm to 900 nm in wavelength.

The 35th aspect of the present invention is the optical pickup according to the 33rd aspect of the present invention, wherein one light from the plurality of light sources converged by any of the plurality of objective lenses on the optical information recording medium is 380 nm to 420 nm in wavelength, and the other light from the plurality of the light sources converged by any of the other of the plurality of objective lenses on the optical information recording medium is 380 nm to 420 nm and 600 nm to 900 nm in wavelength.

The 36th aspect of the present invention is an optical information recording and reproducing device comprising:

the optical pickup according to the 33rd aspect of the present invention;

a driving part which drives an optical information recording medium;

a driving controlling part which at least controls the driving part and the actuator of the optical pickup; and

an information processing part which processes information recorded in or reproduced from the optical information recording medium.

According to the present invention described above, the tilt of the objective lens and actuator can be easily adjusted without causing breakdown of the wire for holding the movable part, for example, at the time of adjusting the optical pickup having two objective lenses to cope with writing into and reading from the optical information recording medium in plural formats.

According to the present invention described above, the optical pickup having a plurality of objective lenses can be produced while tilt is being simply adjusted.

### BRIEF DESCRIPTION OF THE DRAWINGS

FIG. 1(a) is a figure describing a method of adjusting the tilt of an objective lens and an adjusting device related to the first embodiment of the present invention;

FIG. 1(b) is a figure describing a method of adjusting the tilt of an objective lens and an adjusting device related to the first embodiment of the present invention;

FIG. 1(c) is a figure describing a method of adjusting the tilt of an objective lens and an adjusting device related to the first embodiment of the present invention;

FIG. 1(d) is a figure describing a method of adjusting the tilt of an objective lens and an adjusting device related to the first embodiment of the present invention;

FIG. 1(e) is a figure describing a method of adjusting the tilt of an objective lens and an adjusting device related to the first embodiment of the present invention;

FIG. 2(a) is a figure describing a method of adjusting the tilt of an objective lens and an adjusting device related to the second embodiment of the present invention;

FIG. 2(b) is a figure describing a method of adjusting the tilt of an objective lens and an adjusting device related to the second embodiment of the present invention;

FIG. 2(c) is a figure describing a method of adjusting the tilt of an objective lens and an adjusting device related to the second embodiment of the present invention;

FIG. 2(d) is a figure describing a method of adjusting the tilt of an objective lens and an adjusting device related to the second embodiment of the present invention;

FIG. 3(a) is a top view describing the configuration of a flat part formed on the objective lens related to the third embodiment of the present invention;

FIG. 3(b) is a side view describing the configuration of a flat part formed on the objective lens related to the third embodiment of the present invention;

FIG. 3(c) is a bottom view describing the configuration of a flat part formed on the objective lens related to the third embodiment of the present invention;

FIG. 4(a) is a front view describing the configuration of a reflective part formed on a driving part related to the third embodiment of the present invention;

FIG. 4(b) is a top view describing the configuration of a reflective part formed on a driving part related to the third embodiment of the present invention;

FIG. 5 is a block diagram of an optical information recording and reproducing device related to the fourth embodiment of the present invention;

FIG. 6 is a figure describing a method of adjusting the tilt of the objective lens related to the first embodiment of the present invention; and

FIG. 7 shows one example of the principal components of a device for performing a conventional method of adjusting an optical head.

### DESCRIPTION OF SYMBOLS

1. First laser beam

2. Second laser beam

3. Reflecting prism

4. Base

5. Movable part

6. First objective lens

7. Second objective lens

8. First cover glass

9. Second cover glass

10. First microscope

11. Second microscope

12. First camera

13. Second camera

14. Camera controller

15. Monitor display

16. First tilt adjusting mechanism

17. Second tilt adjusting mechanism

18. Laser beam

19. Automatic collimator

20. Third tilt adjusting mechanism

21a. Housing part

21b. Wire

21c. Printed circuit board

22. Actuator

23. First light source

24. Second light source

25. First collimator lens

26. Second collimator lens

27. First beam splitter

28. Second beam splitter

29. First lens

30. Second lens

31. First optical detector

32. Second optical detector

33. First optical information recording medium

34. Second optical information recording medium

35. Motor

36. Arithmetic processing unit

37. Processing circuit

38. Optical pickup

39. Barcode sticker

40. Optical pickup driving circuit

61a, 61b. Flat part

62a. Outgoing surface

62b. Incoming surface

51. Reflecting part

70. Optical information recording and reproducing device

101. Housing

102. Deflection prism

103. Actuator

104. Screw

105. Objective lens

106. Cover glass

107. Microscope

108. Camera

109. Camera controller

110. Monitor display

111. Laser beam

### BEST MODE FOR CARRYING OUT THE INVENTION

The present embodiment of the present invention is described below with reference to the drawings.

### FIRST EMBODIMENT

In the first embodiment is described one example of a method of adjusting the tilt of an objective lens, a method of manufacturing an optical pickup, a device for adjusting the tilt of an objective lens and optical pickup according to the present invention.

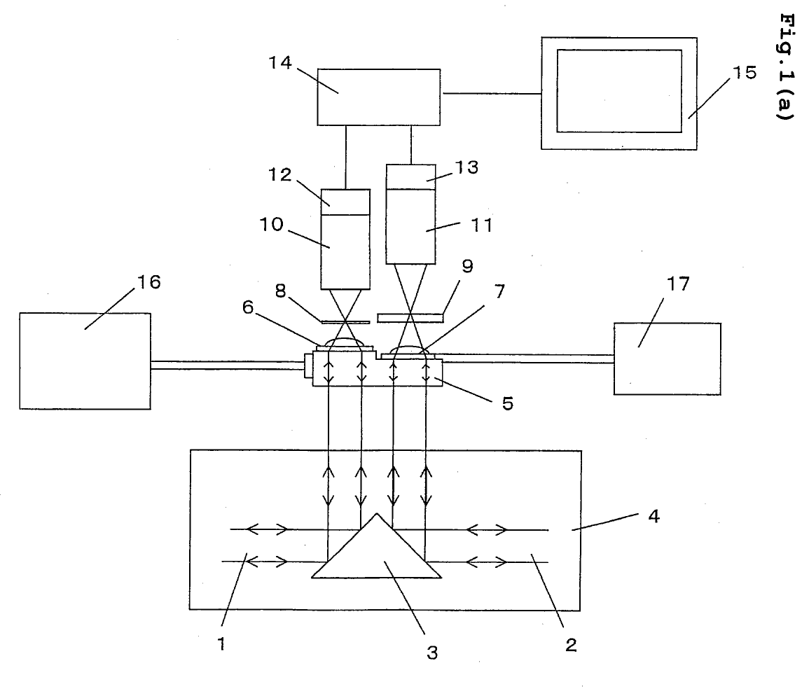

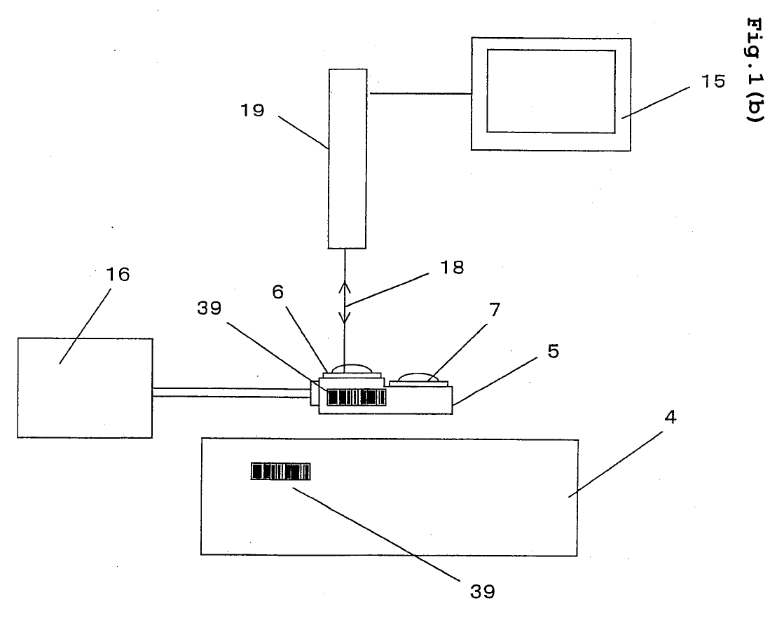

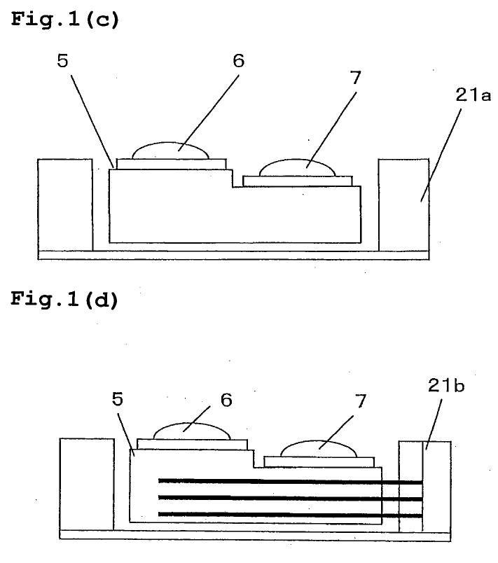

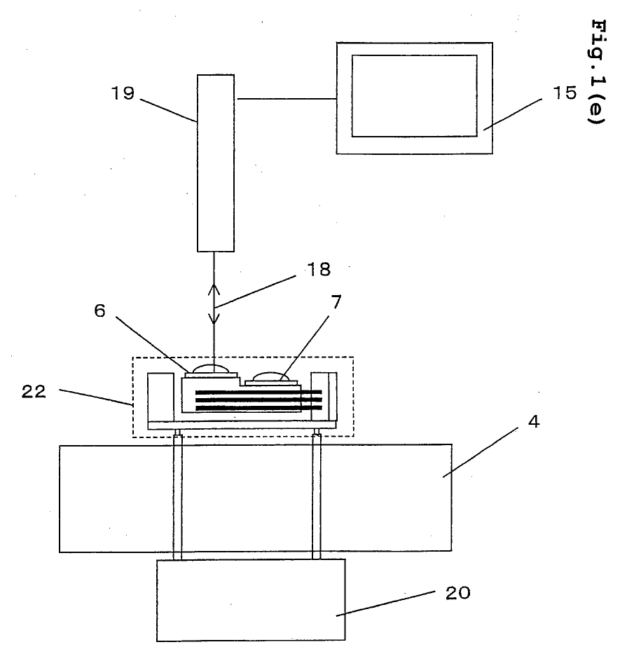

FIG. 1 is a block diagram of a device for adjusting the tilt of an objective lens according to the first embodiment of the present invention.

The following describes how the device for adjusting the tilt of an objective lens works according to the first embodiment using FIG. 1 in the order of FIGS. 1(a), 1(b), 1(c), 1(d) and 1(e), thereby describing one embodiment of a method of adjusting the tilt of an objective lens and a method of manufacturing an optical pickup.

In FIG. 1(a), reference numerals 1 to 7 signify composing elements of the optical pickup. Reference numeral 1 denotes a first laser beam for adjustment corresponding to the light source of the optical pickup, 2 a second laser beam for adjustment corresponding to the light source of the optical pickup, 3 a reflecting prism for reflecting the first and the second laser beam 1 and 2 toward their respective objective lenses, 4 a housing of the optical pickup, 5 a movable part of the actuator, 6 a first objective lens and 7 a second objective lens.

Reference numerals 8 to 15 indicate a spot observation system for evaluating the shape of a convergence spot of convergent light emitted from the first and the second objective lens in the optical pickup. Reference numerals 8 and 9 mean a first and a second cover glass respectively which are optically equivalent in thickness to the protective layer of an optical information recording medium into or from which information is recorded or reproduced by the first and the second objective lens 6 and 7.

Reference numerals 10 and 11 represent a first and a second microscope for imaging a first and a second emission light from the first and the second objective lens 6 and 7 on a first and a second camera 12 and 13 respectively. The spot images received with the first and the second camera 12 and 13 are displayed on the screen of a monitor display 15 through a camera controller 14.

Reference numeral 16 expresses a first tilt adjusting mechanism for temporarily fixing the movable part 5, which is capable of adjusting the orientation and the tilt of the movable part 5. Reference numeral 17 means a second tilt adjusting mechanism for temporarily fixing the second objective lens 7. The first objective lens 6 is fixed to the movable partpart 5, so that the tilt of the first objective lens can be adjusted with the first tilt adjusting mechanism 16. The second objective lens 7 is not fixed to the movable part 5, so that the tilt thereof is directly adjusted with the second tilt adjusting mechanism 17.

The first tilt adjusting mechanism preferably arranges the movable part 5 in such a position as to correspond to a position where the optical pickup has been actually installed on the housing 4, but the movable part 5 may be arranged in an arbitrary position.

In the above configuration, the housing 4 and the movable part 5 correspond to a base and a movable part of the present invention respectively. The first and the second objective lens 6 and 7 correspond to a plurality of objective lenses of the present invention. A spot observation system composed of the first and the second cover glass 8 and 9, the first and the second microscope 10 and 11, the first and the second camera 12 and 13, the camera controller 14 and the monitor display 15, the first tilt adjusting mechanism 16 and the second tilt adjusting mechanism 17 correspond to the first tilt adjusting part of the present invention.

For the procedures for adjustment by using the present device, the first and the second microscope 10 and 11 are focused and the first and the second objective lens 6 and 7 are aligned with the surface direction perpendicular to the direction of their optical axis so that spot images formed on the first and the second cover glass 8 and 9 by the first and the second emission light through the first and the second objective lens 6 and 7 respectively, the first and the second emission light being obtained by reflecting the first and the second laser beam 1 and 2 respectively outputted by a light source (not shown) provided inside the housing of the optical pickup from the reflecting prism 3, can be displayed on the monitor display 15.

The objective lenses are aligned with the surface direction perpendicular to the direction of the optical axis so that light quantity distribution of the first emission light from, for example, the first objective lens 6 is approximately symmetrical with respect to the tracking direction of the first objective lens and the radial direction perpendicular to the tracking direction, which provides convergence spot having less coma aberration. This holds true of the second objective lens 7.

In the next place, the tilts of the first and the second objective lens 6 and 7 are adjusted so that a spot image displayed on the screen of the monitor display 15 is optimized, in other words, the main lobe of the spot image is approximately circular and a primary ring appearing around the main lobe is produced rotationally symmetrically with respect to the center of the spot.

As described above, the first objective lens 6 is fixed to the movable part 5 and the tilt of the movable part 5 is adjusted with the first tilt adjusting mechanism 16. The second objective lens 7 is not fixed to the movable part 5 and so configured that is can be adjusted to a tilting direction. The tilt is therefore adjusted with the second tilt adjusting mechanism 17.

The second objective lens 7 is fixed to the movable part 5 and removed from the second tilt adjusting mechanism 17 after the tilt of the first and the second objective lens 6 and 7 has been adjusted.

This integrates the first and the second objective lens 6 and 7 with the movable part 5 to complete the optical pickup component of the present invention. Incidentally, the movable part 5 is preferably kept being held by the first tilt adjusting mechanism 16 to hold a positional relationship between the housing 4 and movable part 5, but the position may be changed.

After the tilt of the first and the second objective lens 6 and 7 has been adjusted, the tilts of the first and the second objective lens 6 and 7 are measured by reflected light of a laser beam 18 emitted from an automatic collimator 19 (refer to FIG. 1(b)). The use of the automatic collimator allows a larger diameter light to be used as the laser beam 18 and enables an angle to be readily detected. Incidentally, the laser beam 18 corresponds to irradiation light to be used for measuring tilt according to the present invention. However, other measuring means can be used instead of the automatic collimator 19.

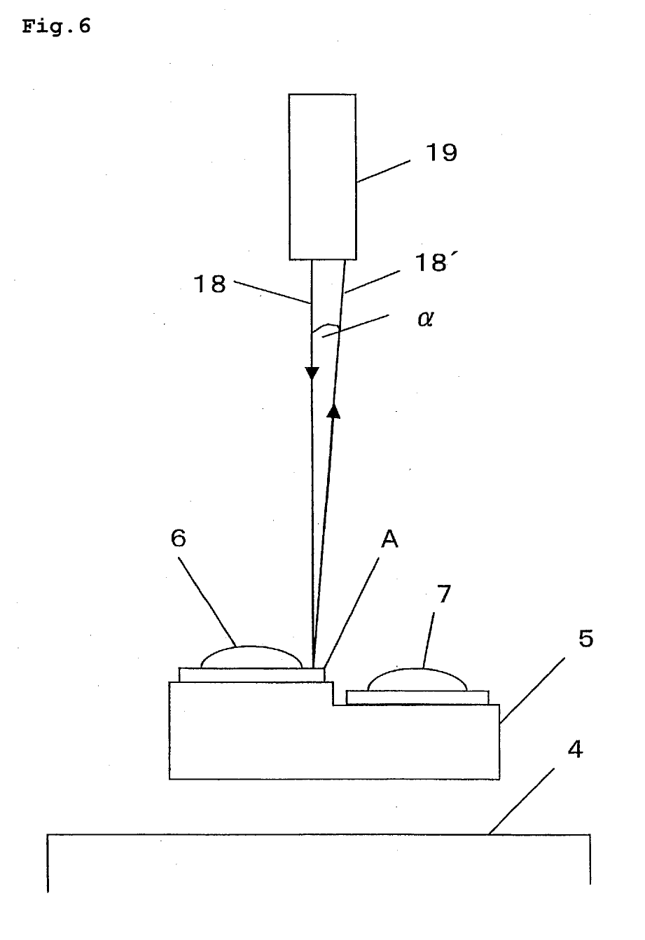

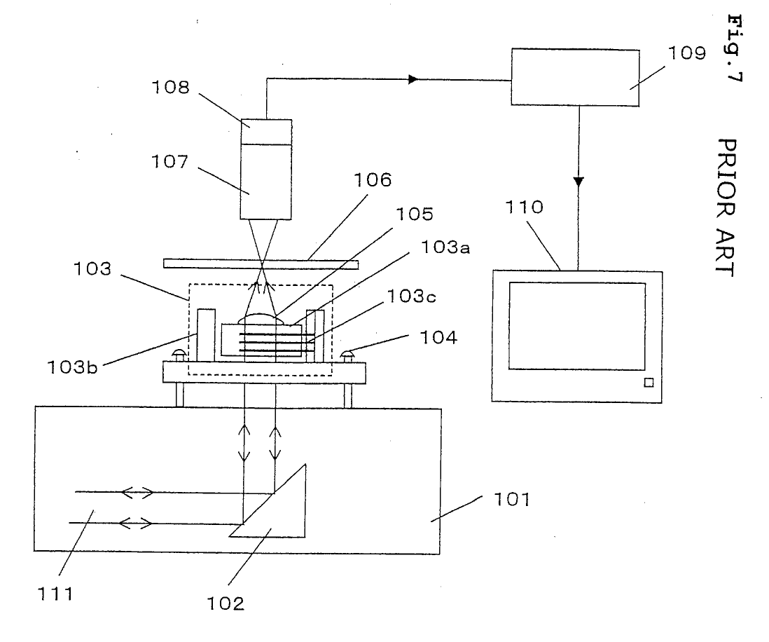

In the following is described measurement on the tilt of the first objective lens 6 with the automatic collimator 19. A flat part with a predetermined reflectivity for reflecting the laser beam 18 is formed at the edge face of the surface on the outgoing side of the first objective lens 6. The flat part is provided in advance on a mold used for molding the lens, so that the part is formed at the same time when the lens is molded, which readily allows it to be secured. In an example shown in FIG. 1(b), the flat face of the objective lens 6 is orthogonal to the optical axis of the laser beam 18 of the automatic collimator 19, which generates reflected light in the same direction as that of incident light. Actually, however, as shown in FIG. 6, the objective lens 6 is tilted by tilt adjustment shown in FIG. 1(a), so that the laser beam 18 emitted from the automatic collimator 19 is reflected from a flat part A used as a reflecting surface to be a reflective laser beam 18′ to return to the automatic collimator 19. A reflection angle α at this point is used as information on the tilt of the first objective lens 6 with respect to the automatic collimator 19. The information on this tilt corresponds to the information on tilt according to the present invention.

The movable part 5 is detached from the first tilt adjusting mechanism 16 to temporarily remove it from the housing 4 after the tilt of the first objective lens 6 has been measured.

The removed movable part 5 is arranged in the separately prepared housing part 21a as shown in FIG. 1(c) and connected to the housing part 21a with a wire 21b for driving as shown in FIG. 1(d) to integrally assemble and complete an actuator 22. An assembly process for completing the actuator 22 corresponds to the assembly process according to the present invention.

As shown in FIG. 1(e), the completed actuator 22 is again temporarily fixed to a predetermined position on the housing 4. The actuator 22 at this point is fixed in a way that the housing part 21a is held by a third tilt adjusting means 20 from the bottom of the housing 4.

In this state, the tilt of the whole actuator 22 is adjusted with the third tilt adjusting means 20 so that the tilt of the first objective lens 6, i.e., the state shown in FIG. 1(b), more specifically the positional relationship of the movable part 5 including the first objective lens 6 to the automatic collimator 19, can be reproduced by light reflected from the foregoing flat part after having irradiating the first objective lens 6 with the laser beam 18 from the automatic collimator 19. Since the movable part 5 and the housing part 21a are integrally connected to each other with the wire 21b in the actuator 22, the control of the tilt of the actuator 22 controls also the attitude of the first objective lens 6 in conjunction therewith. Since the third tilt adjusting means 20 supports the actuator 22 at the bottom of the housing part 21a, the wire 21b will not be subjected to a load due to tilt adjustment.

Finally the actuator 22 is fixed to the top of the housing 4 with the adjusted position held, and the detachment of the actuator 22 from the third tilt adjusting means 20 completes the adjustment of tilt of the objective lens and the actuator of the optical pickup.

The above adjustment enables the tilt of the objective lens and actuator to be adjusted with ease without breaking down the wire holding the movable part at the time of adjusting the tilt of the objective lens of the optical pickup with two objective lenses.

In FIG. 1(a), although the tilts of the first and the second objective lens 6 and 7 are adjusted by visually observing the shape of spot of emission light passing through the objective lens 6 and 7 to the first and the second cover glass 8 and 9, observing wave aberration of emission light of respective objective lenses or coma aberration components, for example, using an interference fringe measuring instrument such as Mach-Zehnder interferometer, Michelson interferometer, Shearing Interferometer to adjust tilt so that the wave aberration and/or the coma aberration is minimized permits further high accurate adjustment, providing convergence spot with less aberration. The use of these measuring instruments brings the advantage of quantitative tilt adjustment. In brief, the first tilt adjustment process of the present invention should not be limited by the contents of a specific method thereof.

In the processes shown in FIGS. 1(a), 1(b) and 1(e) a common device is used for work. The housing 4 also is temporarily removed from the device after the process shown in FIG. 1(b) has been finished and a separate device is used only in the process shown in FIG. 1(e), thereby eliminating the need for waiting the start of the process shown in FIG. 1(e) until the actuator 22 is completed after the process shown in FIG. 1(b) has been finished, which allows working time to be reduced.

In this case, information on the tilt of the first objective lens measured by the automatic collimator 19 requires to be managed. Recording identification information of the movable part 5 and information on tilt of the first objective lens 6 in the movable part 5 facilitates the management of the tilt information. For example, as a method of recording, a barcode sticker 39 can be preferably attached to the movable part 5 to record these pieces of information.

If these pieces of information are managed by combining the movable part 5 with the housing 4, the barcode sticker 39 may be attached to the housing 4. Furthermore, at this point, they can be recorded in an integrated circuit mounted on the housing 4. It is advisable to use the storage area of general-purpose ICs used for controlling the operation of the optical pickup. Tilt information can be recorded in an IC chip or the like to attach it to the housing 4 and/or the movable part 5.

### SECOND EMBODIMENT

In the second embodiment is described another example of a method of adjusting the tilt of an objective lens.

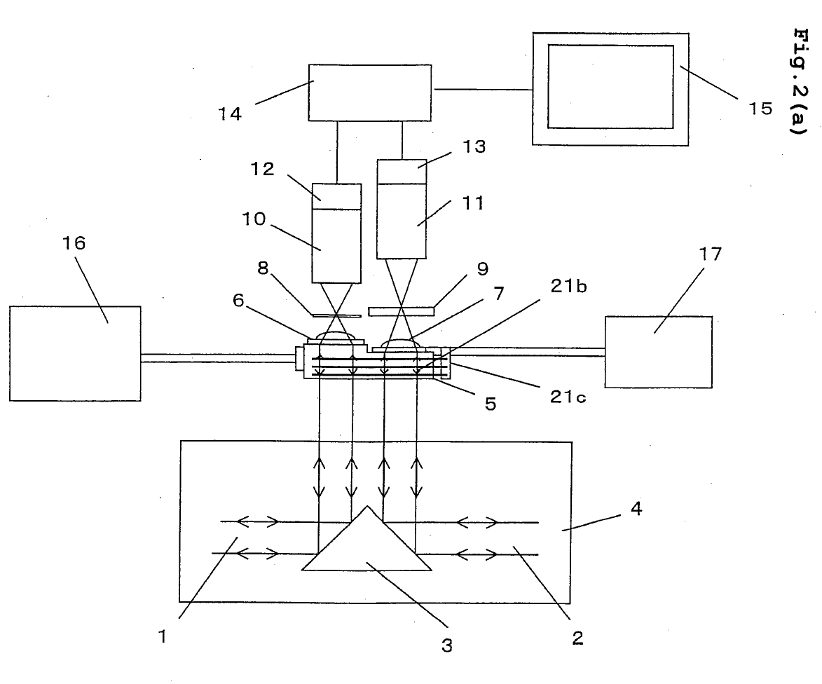

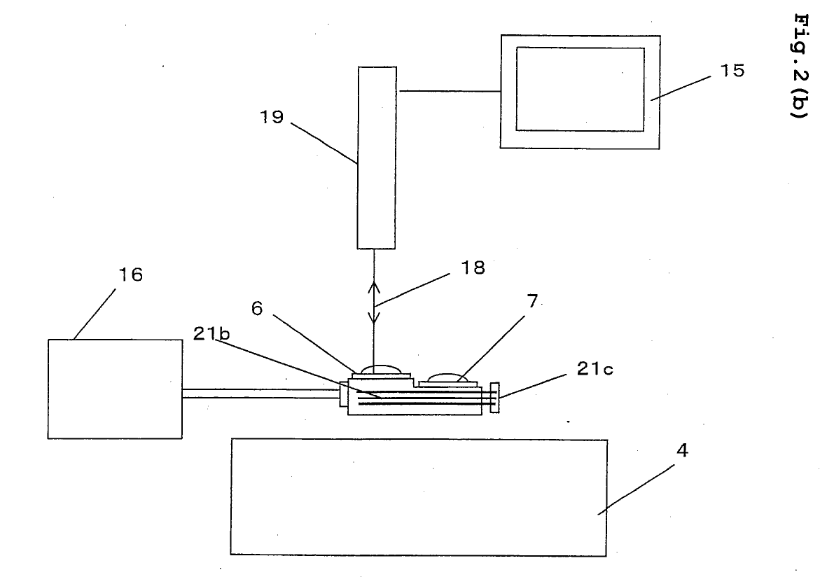

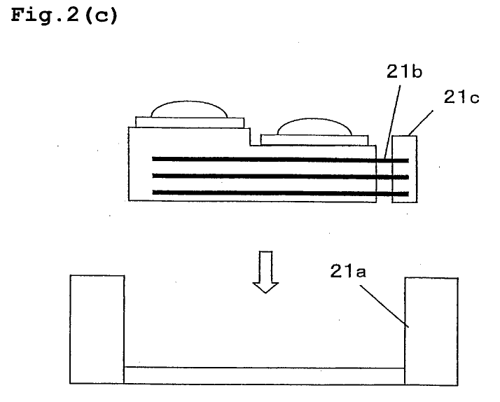

FIG. 2 are figures describing a method of adjusting the tilt of an objective lens in the second embodiment of the present invention. Each part is adjusted by the first, the second and the third tilt adjusting mechanism 16, 17 and 20, which are shown in FIGS. 2(a) to (d), in the same procedures as described in the first embodiment, so that duplicated description is omitted.

In the present embodiment, unlike the first embodiment, the wire 21b for holding the movable part 5 with the housing part 21a of the actuator 22 has been already attached to the movable part 5 at the time of adjusting the tilt of the first and the second objective lens 6 and 7, in the procedure shown in FIG. 2(a). As shown in the same figure, a printed circuit board 21c for keeping an electrical connection between the housing part 21a and the wire 21b is attached beforehand to one end of the wire 21b that is not attached to the movable part 5.

The first tilt adjusting mechanism 16 is held so as to contact only the movable part 5, thereby configurationally not subjecting the wire 21b to a load. The printed circuit board 21c is not so heavy as to burden the wire 21b with a load, so that the board will not affect the wire 21 by tilt adjustment.

The movable part 5 is temporarily detached from the first tilt adjusting mechanism 16 to remove it from the housing 4 after the tilt of the first objective lens 6 has been adjusted. As shown in FIG. 2(c), the movable part 5 to which the wire 21b has been attached is arranged in the housing part 21a, the printed circuit board 21c is connected to the housing part 21a, and the movable part 5 is electrically connected to the housing part 21a, thereby completing the actuator 22.

An attaching work for the wire 21b is complicated and takes a longer assembling tact time. In the present embodiment, however, the wire has already been attached to the movable part 5, shortening the assembling tact time between the adjustment processes shown in FIGS. 2(b) and 2(d) to allow stand-by time for the device to be reduced and to improve workability.

### THIRD EMBODIMENT

In the third embodiment is described one example of an objective lens and a movable part composing the optical pickup component according to the present invention.

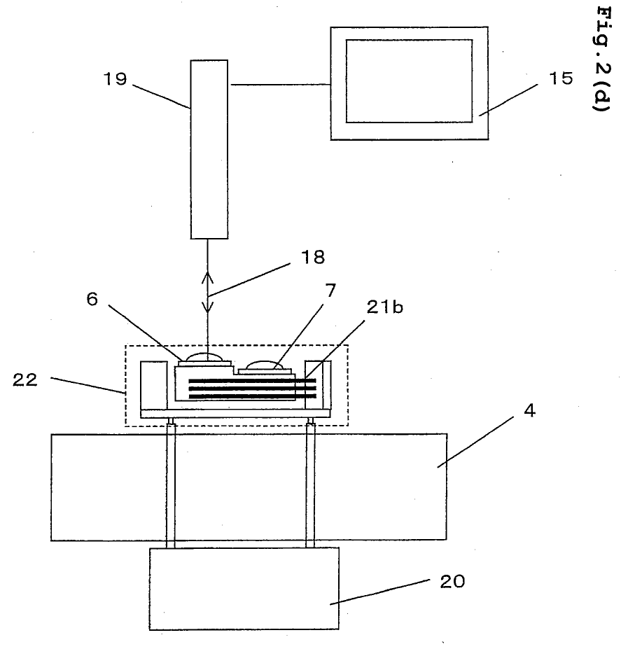

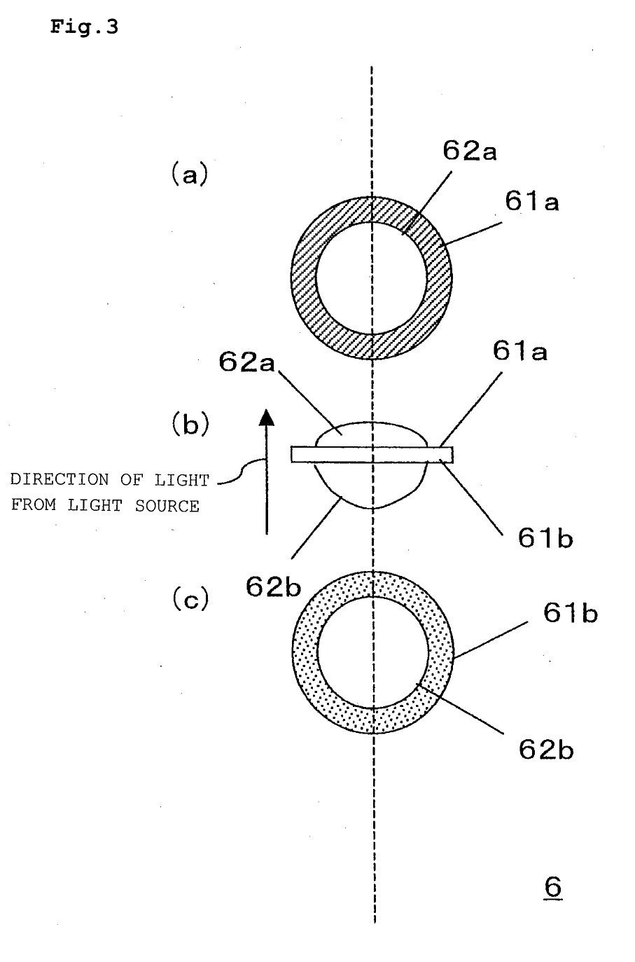

In the first and the second embodiment, the flat part acting as a surface reflecting the laser beam 18 from the automatic collimator 19 is formed on the surface of outgoing side of the first objective lens. The detailed configuration thereof is shown in FIGS. 3(a) to 3(c). The first objective lens 6 is exemplified in the following description. The same configuration is applicable also to the second objective lens.

FIGS. 3(a), 3(b) and 3(c) show the top view, side view and bottom view of the first objective lens 6 respectively. In each figure, a flat part 61a being a flat surface is provided on the edge of the lens including the edge part thereof on the outgoing side of light from the light source of the optical pickup and the similar flat part 61b is provided on the incoming side of light from the light source. As shown in FIGS. 3(a) and 3(c), the flat parts 61a and 61b are formed as annular area surrounding the circumference of incoming and outgoing surface of light on the objective lens 6 by taking advantage of the shape of the edge part.

It is desirable that the flat parts 61a and 62b are 0.1 mm or more in width “w” to obtain better reflection. If the width is less than 0.1 mm, the quantity of reflective light is insufficient, which does not enable light reflected from the flat parts 61a and 61b to be discriminated from diffracted light from the edge surface of the flat parts 61a and 61b. This may make it difficult to detect the angle of the first objective lens 6.

Antireflection coating can be applied on the incoming and the outgoing surface 62b and 62a of the first objective lens 6 using dielectric film adapted to wavelength of light passing through the first objective lens 6 to improve transmissivity of light passing therethrough; however, the antireflection coat is not 100% in transmissivity, for example, approximately 98%, so that reflective light can be obtained, which allows the angle of the first objective lens 6 to be detected.

If the flat parts 61a and 61b are less parallel to each other, it may be difficult to detect the angle of the first objective lens 6 because reflective light is doubly returned from the flat parts 61a and 61b. Roughening the lower surface (b) to diffuse light makes it easy to detect the angle of the first objective lens 6 because light reflects only from the upper surface (a).

A surface reflecting the laser beam 18 from the automatic collimator 19 is not necessarily provided on the flat surface formed on the first objective lens 6, but can be formed on the movable part 5 of the actuator 22. This is because, in the first and the second embodiment, the tilts of the first and the second objective lens 6 and 7 are detected and adjusted by adjusting the movable part 5 integrated with the lenses and the tilts of the first and the second objective lens 6 and 7 are directly detected as that of the movable part 5.

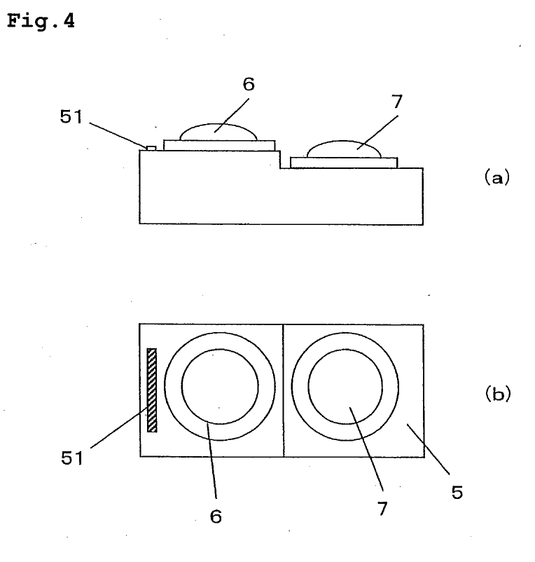

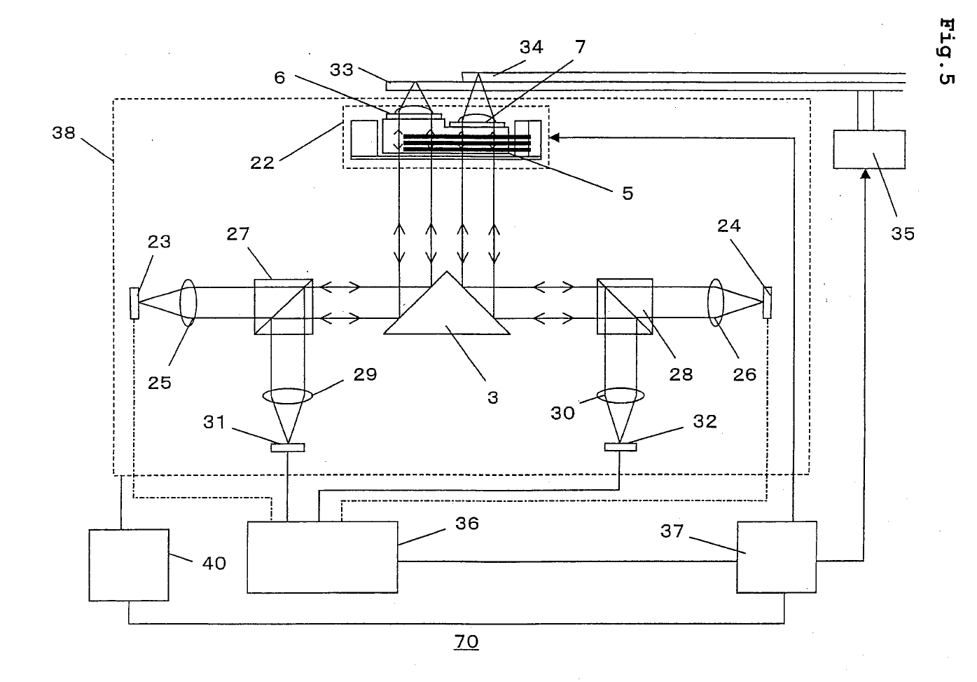

FIGS. 4(a) and 4(b) are an example in which a reflecting part is provided on the movable part 5. FIG. 4(a) is a front view of the movable part 5 and FIG. 4(b) is a top view of the movable part 5. As shown in each figure, a reflecting part 51 is provided on the upper surface of the movable part 5, i.e., on the light outgoing side of each objective lens.

The formation of the flat part on the movable part eliminates the need for securing sufficient flat part at the edge part of the first objective lens 6, making it possible to thin the edge part, that is to say, to reduce the width “w” of the flat part when viewed from FIG. 4(a) being a top view to shorten the outer dimension, which allows the weight of the first objective lens 6 to be reduced. As a result, the movable part 5 is lightened to improve the frequency characteristic of the actuator 22.

### FOURTH EMBODIMENT

In the forth embodiment is described an optical pickup according to the present invention and an example in which the optical pickup is applied to an optical information recording and reproducing device for recording a signal in and reproducing it from an optical information recording medium.

FIG. 5 schematically shows the configuration of an optical information recording and reproducing device in the fourth embodiment. The configuration of an optical information recording and reproducing device 70 shown in the same figure is equipped with an optical pickup 38 described in the embodiments 1 to 3 of the present invention, motor 35, arithmetic processing unit 36, optical pickup driving circuit 40 and processing circuit 37. The same reference characters are used for the same or equivalent elements as in FIG. 1 to omit detailed descriptions.

In the optical pickup 38, the lights emitted through the first and the second objective lens 6 and 7 are converged on the first and the second optical information recording medium 33 and 34 respectively.

The lights reflected from the first and the second optical information recording medium 33 and 34 pass through the first and the second objective lens 6 and 7, are reflected from the reflecting prism 3 and from a first and a second beam splitter 27 and 28 and converged on the first and the second optical detector 31 and 32 by the first and second converging lens 29 and 30 respectively.

The outputs from the first and the second optical detector 31 and 32 cause the arithmetic processing unit 36 to output a focus error signal showing a focusing state of light on the first and the second optical information recording medium 33 and 34 and a tracking error signal showing a position irradiated with light according to the converged light. At this point, the focus and the tracking error signals are detected by known technique, for example, astigmatism method, push-pull method and so forth.

A focus control means (not shown) controls the position of the first and the second objective lens 6 and 7 in the direction of the optical axis according to the focus error signal so that light being in focus is always converged on the first and the second optical information recording medium 33 and 34. A tracking control means (not shown) controls the position of the first and the second objective lens 6 and 7 according to the tracking error signal so that light is converged on a desired track on the first and the second optical information recording medium 33 and 34. The first and the second optical detector 31 and 32 also provide information recorded on the first and the second optical information recording medium 33 and 34. Incidentally, the composing parts except the actuator 22 in the optical pickup 38 are contained in the housing 4 in the embodiments 1 and 2.

The following describes how the optical information recording and reproducing device 70 works. First, loading the optical information and reproducing device 70 with the first or the second optical information recording medium 33 or 34 causes the processing circuit 37 to output a signal for rotating a motor 35, thereby starting the motor. Secondly, the processing circuit 37 drives the first or the second light source 23 or 24 to emit light. The light emitted from the first or the second light source 23 or 24 is reflected from the first or the second optical information recording medium 33 or 34 and incident on the first or the second optical detector 31 or 32.

The first optical detector 31 or the second optical detector 32 outputs the focus error signal showing focusing state of light on the first or the second optical information recording medium 33 or 34 and the tracking error signal showing a position irradiated with light. The processing circuit 37 outputs a signal for controlling the actuator 22 according to these signals, thereby converging the light emitted from the first or second light source 23 or 24 on the desired track of the first or the second optical information recording medium 33 or 34. The processing circuit 37 reproduces information recorded in the first or the second optical information recording medium 33 or 34 according to a signal outputted from the first or the second optical detector 31 or 32. When information is recorded in the first or the second optical detector 31 or 32, the arithmetic processing unit 36 outputs a modulated electric signal to the first light source 23 or the second light source 24 to cause each part to perform the same operation as at the time of the reproduction mode to adjust tracking and focusing, thereby executing optical data writing in the media. For the move on the information recording surface of the first or the second optical information recording medium 33 or 34, the optical pickup driving circuit 40 causes the optical pickup 38 to move to the radial direction of each medium by the control of the processing circuit 37.

In the optical information recording and reproducing device 70, if the light converged on the first optical information recording medium 33 with the first objective lens 6 is 380 nm to 420 nm in wavelength and the light converged on the second optical information recording medium 34 with the second objective lens 7 is 600 nm to 900 nm in wavelength, information can be recorded in or reproduced from, for example, Blu-ray disc with the first light source 23 and it can also be recorded in or reproduced from DVD and CD with the second light source 24. Furthermore, in the optical information recording and reproducing device 70, if the light converged on the first optical information recording medium 33 with the first objective lens 6 is 380 nm to 420 nm in a wavelength, and a single or plural light converged on the second optical information recording medium 34 with the second objective lens 7 is 380 nm to 420 nm and 600 nm to 900 nm in a wavelength, information can be recorded in or reproduced from, for example, Blu-ray disc with the first light source 23 and it can also be recorded in or reproduced from HD-DVD, DVD, or CD with the second light source 24.

In the above configuration, the motor 35, arithmetic processing unit 36 and processing circuit 37 correspond to the driving part, information processing part and driving controlling part of the present invention respectively.

According to the above embodiments of the present invention, the optical pickup with a plurality of objective lenses can be produced while tilt is simply being adjusted. In an optical pickup having two objective lenses for adapting recording information into or reproducing it from plural-formatted optical information recording media, the tilt of the objective lens and actuator can be easily adjusted in the optical pickup assembly process to reduce burden to an operator and to enable the manufacture of the optical pickup and optical information recording and reproducing device with the optical pickup having less dispersion in quality. Such an optical pickup and optical information recording and reproducing device are useful for a magneto-optical recording device and an optical information recording and reproducing device such as DVD, Blu-ray disc and other devices using optical information recording medium and are applicable to the optical system of a hologram recording device and a future super high density recording and reproducing device and the devices themselves.

### INDUSTRIAL APPLICABILITY

A method of adjusting the tilt of an objective lens, a method of manufacturing an optical pickup, a device for adjusting the tilt of an objective lens, optical pickup component, optical pickup and optical information recording and reproducing device related to the present invention have the effect of enabling the optical pickup with plural objective lenses to be manufactured while tilt is simply being adjusted and are useful for a method of adjusting the tilt of an objective lens, a method of manufacturing an optical pickup, a device for adjusting the tilt of an objective lens, optical pickup component, optical pickup and optical information recording and reproducing device.

1. A method of adjusting the tilt of an object lens in an optical pickup having a plurality of light sources, an optical pickup component with a plurality of objective lenses which converge light from the plurality of light sources on an optical information recording medium and a movable part which holds the plurality of objective lenses, an actuator which drives the movable part of the optical pickup component, and a base on which the actuator is arranged and an optical system which introduces light emitted from the plurality of light sources to the plurality of objective lenses is constituted, the method comprising:
a first tilt adjustment step of adjusting the tilt of the plurality of objective lenses with respect to the optical information recording medium with the optical pickup component temporarily arranged at a predetermined position on the base; and
a tilt detection step of detecting the tilt of the plurality of objective lenses after the first tilt adjustment step has been completed.

2. The method of adjusting the tilt of the objective lens according to claim 1, wherein
at least one of the plurality of objective lenses of the optical pickup component is fixed to the movable part in advance,
the remainder of the plurality of objective lenses are held inside the movable part in such a manner that tilt thereof is adjustable with respect to the optical information recording medium,
the first tilt adjustment step for the objective lens fixed to the movable part is performed by moving the movable part, and the step for the remainder of the objective lenses is performed by directly moving the lenses, and
the method further comprises
a step of completing the optical pickup component by fixing the remainder of the objective lenses to the movable part after the first adjustment step has been completed.

3. The method of adjusting the tilt of the objective lens according to claim 1, wherein at least any one of the movable part and the plurality of objective lenses has a reflecting part which reflects light, and
the tilt detection step uses irradiation light for measuring tilt with respect to the reflecting part.

4. The method of adjusting the tilt of the objective lens according to claim 3, wherein the reflecting part is a reflecting mirror provided on the movable part.

5. The method of adjusting the tilt of the objective lens according to claim 3, wherein the reflecting part is provided on at least any one of the plurality of objective lenses and has a flat part formed at the edge part of a surface where light from the light source is incoming or at the edge part of a surface where light from the light source is outgoing, in the objective lens.

6. The method of adjusting the tilt of the objective lens according to claim 5, wherein the flat part is formed around the periphery of the incoming or the outgoing surface and is an annular area having a predetermined width “w” (where, w≧0.1 mm).

7. The method of adjusting the tilt of the objective lens according to claim 5, wherein the reflecting part has a flat part also on the side where the reflecting part does not have the flat part on the incoming or the outgoing surface, and
one of the flat parts is a mirror plane reflecting light and the other of the flat parts is a rough surface diffusing light.

8. The method of adjusting the tilt of the objective lens according to claim 7, wherein the flat part on the incoming surface is the rough surface.

9. The method of adjusting the tilt of the objective lens according to claim 1, wherein the plurality of objective lenses are two objective lenses; the first and the second one.

10. The method of adjusting the tilt of the objective lens according to claim 1, further comprising a recording step of recording information on the tilt of the objective lenses detected by the tilt detection step.

11. The method of adjusting the tilt of the objective lens according to claim 10, wherein the recording step is such that the information on tilt is recorded in at least any one of the base, the optical pickup component and the actuator.

12. The method of adjusting the tilt of the objective lens according to claim 10, wherein the recording step is performed in such a manner that the information on tilt is recorded by barcode information.

13. The method of adjusting the tilt of the objective lens according to claim 10, wherein the recording step is performed in such a manner that the information on tilt is recorded in an integrated circuit provided on the base.

14. The method of adjusting the tilt of the objective lens according to claim 1, wherein the tilt detection step is performed using an automatic collimator.

15. The method of adjusting the tilt of the objective lens according to claim 1, wherein the first tilt adjustment step is performed in such a manner that outgoing light spots converged by the plurality of objective lenses become symmetrical with respect to the optical axis of light from the light source and are minimized.

16. The method of adjusting the tilt of the objective lens according to claim 1, wherein the first tilt adjustment step is performed in such a manner that the coma aberration of light outgoing from the first and the second objective lenses is minimized.

17. A method of manufacturing an optical pickup having a plurality of light sources, an optical pickup component with a plurality of objective lenses which converge light from the plurality of light sources on an optical information recording medium and a movable part which holds the plurality of objective lenses, an actuator which drives the movable part of the optical pickup component, and a base on which the actuator is arranged and an optical system which introduces light emitted from the plurality of light sources to the plurality of objective lenses is constituted, the method comprising:
a combining step of integrally combining the optical pickup component with the actuator; and
a fixing step of fixing the optical pickup component combined with the actuator to the base; wherein
the fixing step has a second tilt adjustment step of adjusting the tilt of the actuator combined with the optical pickup component so that the tilt of the plurality of objective lenses obtained at the tilt detection step in the method of adjusting the tilt of the objective lenses according to claim 1 is reproduced.

18. The method of manufacturing the optical pickup according to claim 17, wherein the combining step is such that the optical pickup component is connected to the actuator with a wire for driving the optical pickup component.

19. The method of manufacturing the optical pickup according to claim 18, wherein the wire is connected to the pickup component at least prior to the start of the combining step.

20. A device for adjusting the tilt of an objective lens in an optical pickup having a plurality of light sources, an optical pickup component with a plurality of objective lenses which converge light from the plurality of light sources on an optical information recording medium and a movable part which holds the plurality of objective lenses, an actuator which drives the movable part of the optical pickup component, and a base on which the actuator is arranged and an optical system which introduces light emitted from the plurality of light sources to the plurality of objective lenses is constituted, the device comprising:
a first tilt adjusting part which adjusts the tilt of the plurality of objective lenses with respect to the optical information recording medium with the optical pickup component temporarily arranged at a predetermined position on the base; and
a tilt detecting part which detects the tilt of the plurality of objective lenses after the first step has been completed.

21. The device for adjusting the tilt of an objective lens according to claim 20, further comprising a recording part which records information on the tilt of the objective lens detected by the first tilt adjusting part.

22. The device for adjusting the tilt of an objective lens according to claim 21, wherein the recording part records the information on the tilt of the objective lens in at least any one of the base, the optical pickup component and the actuator.

23. The device for adjusting the tilt of an objective lens according to claim 22, wherein the recording part records the information on the tilt by barcode information.

24. The device for adjusting the tilt of an objective lens according to claim 22, wherein the recording part records the information on the tilt in an integrated circuit provided in the base.

25. The device for adjusting the tilt of an objective lens according to claim 20, wherein the first tilt adjusting part has an automatic collimator.

26. An optical pickup component comprising:
a plurality of objective lenses which converge light from a plurality of light sources on an optical information recording medium; and
a movable part which holds the plurality of objective lenses; wherein
at least any one of the movable part and the plurality of objective lenses has a reflecting part which reflects light.

27. The optical pickup component according to claim 26, wherein the reflecting part is a reflecting mirror provided on the movable part.

28. The optical pickup component according to claim 26, wherein the reflecting part is provided on at least any one of the plurality of objective lenses and has a flat part formed at the edge part of a surface where light from the light source is incoming or at the edge part of a surface where light from the light source is outgoing.

29. The optical pickup component according to claim 28, wherein the flat part is formed around the periphery of the incoming or the outgoing surface and is an annular area having a predetermined width “w” (where, w≧0.1 mm).

30. The optical pickup component according to claim 28, wherein the reflecting part has a flat part also on the side where the reflecting part does not have the flat part on the incoming or the outgoing surface, and
one of the flat parts is a mirror plane reflecting light and the other of the flat parts is a rough surface diffusing light.

31. The optical pickup component according to claim 28, wherein the flat part on the incoming surface is the rough surface.

32. The optical pickup component according to claim 26, wherein the plurality of objective lenses are two objective lenses; the first and the second one.

33. An optical pickup comprising:
a plurality of light sources;
the optical pickup component according to claim 26;
an actuator which drives the movable part of the optical pickup component; and
a base on which the actuator is arranged and an optical system which introduces light emitted from the plurality of light sources to the plurality of objective lenses is constituted.

34. The optical pickup according to claim 33, wherein one light from the plurality of light sources converged by any of the plurality of objective lenses on the optical information recording medium is 380 nm to 420 nm in wavelength, and the other light from the plurality of the light sources converged by any of the other of the plurality of objective lenses on the optical information recording medium is 600 nm to 900 nm in wavelength.

35. The optical pickup according to claim 33, wherein one light from the plurality of light sources converged by any of the plurality of objective lenses on the optical information recording medium is 380 nm to 420 nm in wavelength, and the other light from the plurality of the light sources converged by any of the other of the plurality of objective lenses on the optical information recording medium is 380 nm to 420 nm and 600 nm to 900 nm in wavelength.

36. An optical information recording and reproducing device comprising:
the optical pickup according to claim 33;
a driving part which drives an optical information recording medium;
a driving controlling part which at least controls the driving part and the actuator of the optical pickup; and
an information processing part which processes information recorded in or reproduced from the optical information recording medium.
